(19) United States
(12) Patent Application Publication
(10) Pub. No.: US 2013/0180921 A1
(43) Pub. Date: Jul. 18, 2013

(54) Positive Displacement Energy Recovery Systems and Methods

(71) Applicant: World Wide Water Solutions, Gilbert, AZ (US)

(72) Inventor: Dennis Chancellor, Gilbert, AZ (US)

(73) Assignee: WORLD WIDE WATER SOLUTIONS, Gilbert, AZ (US)

(21) Appl. No.: 13/744,310

(22) Filed: Jan. 17, 2013

Related U.S. Application Data
(60) Provisional application No. 61/587,538, filed on Jan. 17, 2012.

(51) Int. Cl. C02F 1/44

(52) U.S. Cl. CPC C02F 1/441
USPC 210/652; 210/251

(57) ABSTRACT

The inventive subject matter provides apparatus, systems and methods in which a feed fluid entering a filtration system is mixed with a portion of a reject fluid. The re-introduced reject fluid is preferably pressurized using a positive displacement pump, and more preferably using a work exchange pump having a translatable piston. The re-introduced reject fluid is preferably pressurized to within 10 psi, or more preferably to within 5 psi, of the uncombined feed fluid. The filtration system can have one or more filters.

This application claims priority to U.S. provisional patent application Ser. No. 61/587538 filed Jan. 17, 2012, the disclosure of which is incorporated herein in its entirety.

### FIELD OF THE INVENTION

The field of the invention is filtration systems and methods.

### BACKGROUND

To reduce the energy requirements of a reverse osmosis pump system, it is known to include a pumping system that can conserve a portion of the pressure of an incoming stream to thereby increase the pressure of a second stream. See, e.g., U.S. pat. publ. no. 2008/0296224 to Cook, et al. (publ. Dec. 2008). However, such system requires electricity to operate the pumping system, which increases the overall energy use of the system.

Cook and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

To further reduce the energy requirements of filtrations systems, it is known to utilize a work exchange pump, such as that discussed in U.S. pat. publ. no. 2005/0035048 to Chancellor et al. (publ. February 2005) and U.S. Pat. No. 6,017,200 to Childs, et al. However, such systems are complex, which increases the maintenance and energy costs of the systems.

Thus, there is still a need for filtration systems having reduced energy requirements.

### SUMMARY OF THE INVENTION

The inventive subject matter provides apparatus, systems and methods in which a feed fluid entering a filtration system is mixed with a portion of a reject fluid. The re-introduced reject fluid is preferably pressurized using a positive displacement pump, and more preferably using a work exchange pump having a translatable piston. The re-introduced reject fluid is preferably pressurized to within 10 psi, or more preferably to within 5 psi, of the uncombined feed fluid. The filtration system can have one or more filters.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A is a schematic of a positive displacement energy recovery unit for a pressurized filtration system.

FIG. 1B is a schematic of the positive displacement energy recovery unit of FIG. 1, at a different point in operation of the energy recovery unit.

### DETAILED DESCRIPTION

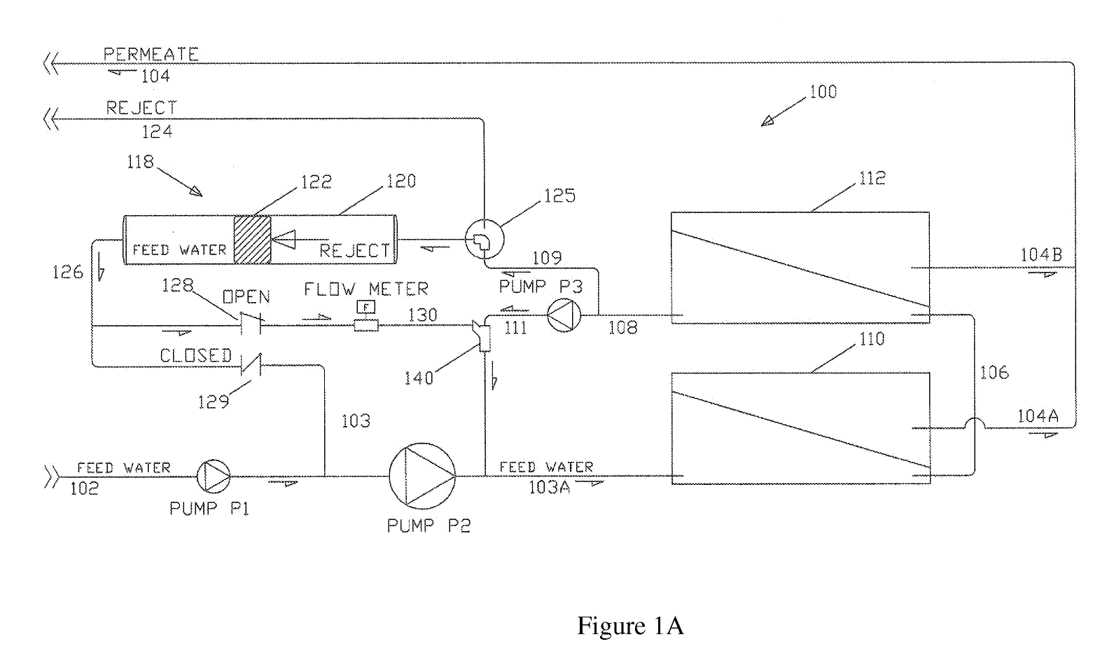

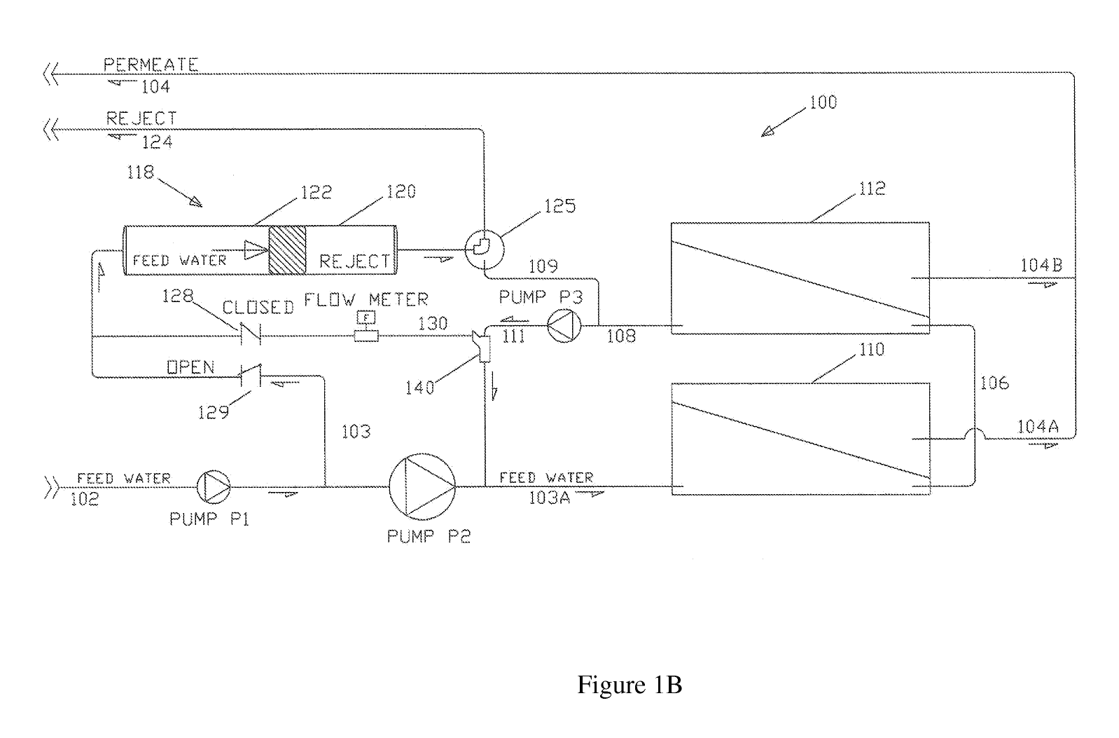

One embodiment of a filtration system 100 is shown in FIGS. 1A and 1B. System 100 can receive a feedwater stream 102 that can flow past one or both of pumps P1 and P2, which thereby increase a pressure of the feedwater stream 102 to approximately 125-200 psi, and more preferably at least about 150 psi, although the specific pressure can vary depending upon the application. For example, the pressure of a feedwater stream comprising brackish water will likely be less than that of a feedwater stream comprising salt water because the brackish water will require less pressure to operate the filter.

System 100 can include a first filter 110 configured to receive at least a portion of feedwater stream 102 and produce a permeate stream 104A and reject stream 106, which can then be fed into a second filter 112 to produce a second permeate stream 104B and a reject stream 108. In this manner, the feedwater stream 102 can be passed through multiple filters to remove a larger percentage of impurities from the stream 102 and it is contemplated that the stream 102 could be passed serially through three or more filters although the specific number of filters will depend upon the application. In alternative embodiments, the feedwater stream 102 could be separated into two or more streams and each stream could be passed through one or more filters in parallel.

Permeate streams 104A and 104B can optionally be merged downstream of the filters 110 and 112 as combined stream 104.

Preferred filters include reverse osmosis (RO) filters, and especially preferred RO filters include a filter element and a casing formed about the filter element, such as those described in U.S. utility application titled “Water Purification System With Entrained Filtration Elements” having Ser. No. 13/263819 filed on Oct. 10, 2011. As used herein, the term “filter element” is defined to include all commercially suitable filters including, for example, sand, charcoal, paper, and other media, and any membrane capable of filtering a fluid. The filter element could be of any type, size or manufacturer, and preferably the filter element is selected based upon the commercial application.

A first portion 111 of the reject stream 108 can bypass pump P3 to increase its pressure before it is merged with the feedwater stream 102 downstream of pump P2. By using a smaller pump P3 rather than pump P2 to pressurize the reject stream 108, less energy is advantageously consumed. P2 is used primarily to boost pressure of reject stream 108 and re-circulate feed fluid 108 back into the feed fluid stream 103a (i.e., P2 discharge).

A second portion 109 of the reject stream 108 can be diverted upstream of pump P3 and fed into a lower portion of energy recovery unit. In preferred embodiments, the energy recovery unit comprises a positive displacement pump 118 having a cylindrical unit 120 and piston 122. As shown in FIG. 1A, the higher pressure reject stream 109 causes a piston 122 within pump 118 to translate leftward, which thereby expels a feedwater stream 126 from a left side outlet of pump 118 through mechanical check valve 128. In this manner, the pressure of the feedwater stream 126 can be increased via work exchange with the reject stream 109, which advantageously eliminates a need for an additional in-line pressure booster pump, and its associated energy costs. Preferably, piston 122 is a zero-buoyancy piston to reduce blowby around the piston 122, and also to reduce the pressure loss and friction between the piston 122 and unit 120.

The feedwater stream 126 can be fed into a venturi valve 140 as a result of the negative pressure created as stream 108 flows through the venturi valve 140. This advantageously reduces the energy costs of system 100, as the reject stream 108 does not require a pump between valve 140 and pump 118. It is especially preferred that the positive displacement pump 120 be disposed vertically with respect to a ground level, such that the feedwater stream 128 flowing from pump 118 has a pressure near (preferably with 10 psi, and more preferably within 5 psi) that of feedwater stream 102 without the need for an additional pump.

To reduce the amount of fluids exchanged between opposite sides of piston 122, it is preferred that the difference in pressure between the fluids on each side is less than 10 psi.

After piston 122 reaches a desired left side position within pump 120, a sensor can send a signal to cause L-diverter valve 125 to be rotated to stop flow of the portion 109 of the reject stream 108 to the pump 118, as shown in FIG. 1B. Although valves 128 and 129 are shown as separate valves, it is contemplated that a three-way valve could be substituted for the valves 128 and 129 to thereby further reduce the complexity of system 100. In addition, rather than using L-diverter valve 125, any commercially suitable valve(s) could be used including, for example, actuated gate valves, and ball valves. Separate valves could also be used in place of valve 125 to regulate flow into and out from the pump 118, respectively.

With valve 129 opened and valve 128 closed, a portion 103 of the feedwater stream 102 can be removed upstream of pump P2 and fed into pump 118. As shown in FIG. 1B, the higher pressure feedwater stream 103 causes piston 122 to translate downwardly, which thereby expels the lower pressure reject stream 124 from a lower outlet of pump 118 through valve 125. After the piston 122 reaches a lower portion of the pump 118, a sensor can send a signal to cause L-diverter valve 125 to be rotated to allow the flow of portion 109 of the reject stream 108 to the pump 118, as shown in FIG. 1B.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filtration system, comprising:
a pump configured to pressurize a feed fluid to produce a first pressurized feed fluid stream;
a first filter configured to receive the first pressurized feed fluid stream, and produce therefrom a permeate stream and a reject stream;
a work exchange energy recovery unit fluidly coupled to the first filter, configured to pressurize a portion of the reject stream to produce a second pressurized feed fluid stream; and
wherein the second pressurized feed fluid stream is mixed with the first pressurized feed fluid stream upstream of the first filter.

2. The filtration system of claim 1, wherein the energy recovery unit comprises a positive displacement pump.

3. The filtration system of claim 1, wherein the positive displacement pump comprises a cylinder having a translatable piston.

4. The filtration system of claim 1, wherein the positive displacement pump is configured to pressurize the second pressurized feed fluid stream to a pressure within 10 psi of the a pressure of the first pressurized feed fluid stream entering the first filter.

5. The filtration system of claim 1, wherein the positive displacement pump is configured to pressurize the second pressurized feed fluid stream to a pressure within 5 psi of the a pressure of the first pressurized feed fluid stream entering the first filter.

6. The filtration system of claim 1, further comprising a second filter downstream of the first filter, fluidly intermediate between the first filter and the positive displacement pump.

7. A method of reducing an energy requirement of a filtration system, comprising:
feeding a first pressurized feed fluid stream to an upstream filter;
feeding a reject stream from the first filter to a downstream filter;
using an energy recovery unit to pressurize at least a portion of a reject stream from the downstream to produce a second pressurized feed fluid stream;
feeding the second pressurized feed fluid stream to at least one of the filters.

8. The method system of claim 7, wherein the energy recovery unit comprises a positive displacement pump.

9. The method system of claim 7, wherein the positive displacement pump comprises a cylinder having a translatable piston.

10. The method system of claim 7, wherein the positive displacement pump is configured to pressurize the second pressurized feed fluid stream to a pressure within 10 psi of the a pressure of the first pressurized feed fluid stream entering the first filter.

11. The method system of claim 7, wherein the positive displacement pump is configured to pressurize the second pressurized feed fluid stream to a pressure within 5 psi of the a pressure of the first pressurized feed fluid stream entering the first filter.

12. The method system of claim 7, further comprising a second filter downstream of the first filter, fluidly intermediate between the first filter and the positive displacement pump.
